(19) United States
(12) Patent Application Publication
(10) Pub. No.: US 2026/0202796 A1
(43) Pub. Date: Jul. 16, 2026

(54) SYSTEM FOR ACQUIRING HOLOGRAMS OF DIFFERENT COLORS

(71) Applicant: CUBIXEL CO.,LTD., Seoul (KR)

(72) Inventors: You Seok KIM, Seoul (KR); Eung Joon LEE, Seoul (KR)

(73) Assignee: CUBIXEL CO.,LTD., Seoul (KR)

(21) Appl. No.: 19/127,746

(22) PCT Filed: Aug. 11, 2023
(86) PCT No.: PCT/KR2023/011940

§ 371 Date: May 7, 2025

(30) Foreign Application Priority Data
Nov. 8, 2022 (KR) 10-2022-0147549

(51) Int. Cl. G03H 1/26

(52) U.S. Cl. CPC G03H 1/26; G03H 2222/36; G03H 2223/24; G03H 2225/21

(57) ABSTRACT

A system for acquiring a hologram of a natural color includes a multi-wavelength light source unit that generates light sources having multiple wavelengths, a multi-wavelength interference unit that receives the light sources having the multiple wavelengths and generates a scan beam due to an interference phenomenon, a scanning unit that scans a target object by using the scan beam, a multi-wavelength photodetection unit that detects beams reflected from or transmitting through the target object for each wavelength and converts the beams into electrical signals, and a signal processing unit that numerically processes the electrical signals.

### TECHNICAL FIELD

The present invention relates to a system for acquiring holograms of different colors, and more specifically, to a hologram acquisition system based on scanning holography capable of acquiring information on holograms of different colors for an actual object.

### BACKGROUND ART

In general, an optical scanning hologram system forms a beam pattern having a spatial distribution of a Fresnel zone plate using an interferometer, projects the formed beam pattern onto a target object, collects and detects the light reflected from or transmitting through the target object to acquire a hologram of the object.

Conventionally, a technique for acquiring natural color hologram information of an actual object is disclosed as a method of acquiring a hologram of an object. The technique presents a hologram recording device based on scanning holography that acquires hologram information of an actual object for multiple wavelengths.

However, the conventional technique proposes a technique that uses multiple acousto-optic modulators for each wavelength in order to acquire hologram information of an actual object corresponding to multiple wavelengths. However, when the multiple acousto-optic modulators are used, there is an advantage of being able to simultaneously capture different wavelengths, but there is a disadvantage of increasing a size of the entire system.

The technology that serves as a background of the present invention is disclosed in U.S. Pat. No. 6,760,134 (registered on Jul. 6, 2004).

### DISCLOSURE OF INVENTION

### Technical Problem

The present invention aims to provide a system for acquiring holograms of different colors, which may acquire information on holograms of different colors for an object by using one acousto-optic modulator.

### Solution to Problem

The present invention provides a system for acquiring hologram of different colors by including a multi-wavelength light source unit that generates light sources having multiple wavelengths, a multi-wavelength interference unit that receives the light sources having the multiple wavelengths and generates a scan beam due to an interference phenomenon, a scanning unit that scans a target object by using the scan beam, a multi-wavelength photodetection unit that detects beams reflected from or transmitting through the target object for each wavelength and converts the beams into electrical signals, and a signal processing unit that numerically processes the electrical signals.

Also, the multi-wavelength light source unit may include a first wavelength-selective mirror, a second wavelength-selective mirror, and a first mirror, which are arranged side by side and on which light sources respectively having a first wavelength, a second wavelength, and a third wavelength, each of which is selected from red light, green light, and blue light, are respectively incident side by side, and the first wavelength-selective mirror may transmit the light source having the first wavelength incident on one surface of the first wavelength-selective mirror therethrough, reflect the light sources respectively having the second wavelength and the third wavelength incident on another surface of the first wavelength-selective mirror through the second wavelength-selective mirror and the first mirror, combine the light sources respectively having the first wavelength, the second wavelength, and the third wavelength to pass through one path, and transfer a combined light source to the multi-wavelength interference unit.

Also, the multi-wavelength light source unit may include an optical path combining means that receives first to N^{th} light sources (N is an integer of 2 or more) having different wavelengths, combines the first to N^{th} light sources to pass through one path, and outputs a combined light source.

Also, the optical path combining means may have a structure in which the first to N^{th} light sources are individually incident through N−1 wavelength-selective mirrors and one mirror arranged side by side and are combined to pass through the one path by a wavelength-selective mirror located at an end to be output.

Also, the optical path combining means may have a structure in which the first to N^{th} light sources are individually incident through N wavelength-selective mirrors arranged side by side and are combined to pass through the one path by a wavelength-selective mirror located at an end to be output.

Also, the optical path combining means may have a structure in which the first to N^{th} light sources are individually incident through N beam splitters arranged side by side and are combined to pass through the one path by a beam splitter located at an end to be output.

Also, the multi-wavelength interference unit may include a first beam splitter that receives light sources having multiple wavelengths, splits the light sources into beams that pass through a first path and a second path, and outputs the beams, a multi-wavelength modulator that receives the beam that is split by the first beam splitter and passes through the first path, spatially splits the beam into multiple beams for each wavelength, combines the multipole beams, and outputs a recombined beam, and a second beam splitter that receives the beam passing through the first path through the multi-wavelength modulator and the beam that is split by the first beam splitter and passes through the second path, and interferes the beams with each other to generate the scan beam.

Also, the multi-wavelength modulator may include an acousto-optic modulator that modulates the beam passing through the first path into light having a set frequency and outputs lights obtained by spatially splitting the light for each wavelength at different diffraction angles, and an optical combiner that recombines the lights having respective wavelengths spatially split and output by the acousto-optic modulator and propagates the lights into a free space.

Also, the acousto-optic modulator may modulate the beam passing through the first path into light having a set frequency and outputs the light, and split the light into multiple lights for each wavelength (A) at different diffraction angles (0B) by using an equation below and propagate the multiple lights into the air.

$${θ}_{B} \approx sin {θ}_{B} = \frac{λ}{2 n Λ}$$

wherein A represents a wavelength of incident light, n represents a refractive index of a medium, and A represents a wavelength of a sound wave incident on the medium.

Also, the optical combiner may include multiple collimators that receive lights having respective wavelengths split by the acousto-optic modulator through lenses corresponding to the corresponding wavelengths and individually focus the lights onto respective optical fibers, a combiner that receives lights having respective wavelengths focused by the multiple collimators, combines the lights into one light, and outputs the one light through a single optical fiber, and a terminal collimator that receives a beam combined by the combiner and propagates the beam into a free space.

Also, the optical combiner may have a structure in which N beams having different wavelengths are individually incident through one mirror and N−1 wavelength-selective mirrors arranged side by side and are combined to pass through one path by a wavelength-selective mirror located at an end to be output.

Also, the optical combiner may have a structure in which N beams having different wavelengths are individually incident through N wavelength-selective mirrors arranged side by side and are combined to pass through one path by a wavelength-selective mirror located at an end to be output.

Also, the optical combiner may have a structure in which N beams having different wavelengths are individually incident through N beam splitters arranged side by side and are combined to pass through one path by a beam splitter located at an end to be output.

Also, the multi-wavelength interference unit further may include a first beam curvature generator that receives a beam passing through a first path through the multi-wavelength modulator, converts the beam into a spherical wave having a first curvature, and transfers the spherical wave to the second beam splitter, and a second beam curvature generator that converts a beam, which is split by the first beam splitter and passes through a second path, into a spherical wave having a second curvature and transfers the spherical wave to a second beam splitter.

The second beam splitter may combine the beam passing through the first path through the first beam curvature generator and the beam passing through the second path through the second curvature generator and generate a scan beam having a pattern of a Fresnel plate according to an interference effect due to coherence characteristics of a light source between beams.

Also, the multi-wavelength photodetection unit may include a beam separation unit that receives beams reflected from or transmitting through a target object and splits the beams for each wavelength, and N photodetectors that detect the N beams having respective wavelengths split by the beam separation unit and convert the N beams into electrical signals.

Also, the beam split unit may include a third wavelength-selective mirror, a fourth wavelength-selective mirror, and a second mirror arranged side by side, the third wavelength-selective mirror may receive the beams reflected from or transmitting through the target object, transmit a beam having the first wavelength therethrough, and transfer the beam to a first photodetector, the fourth wavelength-selective mirror may reflect a beam having the second wavelength among beams respectively having the second wavelength and the third wavelength, which are reflected from the third wavelength-selective mirror and transfers the beam having the second wavelength to a second photodetector, and transmit the beam having the third wavelength therethrough and transfer the beam having the third wavelength to the second mirror, and the second mirror may reflect the beam having the third wavelength received from the fourth wavelength-selective mirror and transfer the beam having the third wavelength to a third photodetector.

Also, the beam split unit may be composed of a total of N mirror elements including N−1 wavelength-selective mirrors and one mirror, receive the beams reflected from or transmitting through the target object through one of wavelength-selective mirrors at an end, split the beams for each wavelength through the N mirror elements, and individually transfer split beams to the N photodetectors.

Also, the beam split unit may be composed of N wavelength-selective mirrors, receive the beams reflected from or transmitting through the target object through one of wavelength-selective mirrors at an end, split the beams for each wavelength through the N wavelength-selective mirrors, and individually transfer split beams to the N photodetectors.

Also, the beam split unit may be composed of N beam splitters and N color filters that respectively filter beams having different wavelengths, receive the beams reflected from or transmitting through the target object through one of beam splitters at an end, split the beams into N beams through the N beam splitters, individually transfers the N beams to the N color filters, and individually transfer beams split for each wavelength through the N color filters to the N photodetectors.

### Advantageous Effects of Invention

According to the present invention, it is possible to acquire information on holograms of various wavelengths for an object by using only a single acousto-optic modulator.

Also, unlike the general method of using multiple acousto-optic modulators for signal processing of different multiple wavelengths, only one acousto-optic modulator is required, and thus, a size of the entire system for acquiring holograms of different colors may be reduced.

### BRIEF DESCRIPTION OF DRAWINGS

FIG. 1 is a diagram illustrating a configuration of a system for acquiring holograms of different colors, according to an embodiment of the present invention.

FIG. 2 is a diagram specifically illustrating a configuration of FIG. 1.

FIG. 3 illustrates diagrams of other examples of a multi-wavelength light source unit illustrated in FIG. 2.

FIG. 4 is a diagram illustrating an implementation example of a multi-wavelength modulator of FIG. 2.

FIG. 5 illustrates diagrams of other implementation examples of the multi-wavelength modulator of FIG. 2.

FIG. 6 illustrates diagrams of implementation examples of a beam curvature generator according to an embodiment of the present invention.

FIG. 7 is a diagram illustrating an implementation example of a multi-wavelength photodetection unit of FIG. 2.

FIG. 8 illustrates diagrams of other implementation examples of the multi-wavelength photodetection unit of FIG. 2.

### BEST MODE FOR CARRYING OUT THE INVENTION

Then, embodiments of the present disclosure will be described in detail with reference to the attached drawings such that those skilled in the art may easily implement the present disclosure. However, the present disclosure may be implemented in various different forms and is not limited to the embodiments described herein. In addition, in order to clearly describe the present disclosure with reference to the drawings, parts that are not related to the description are omitted, and similar parts are given similar reference numerals throughout the specification.

Throughout the specification, when a portion is described to be “connected” to another portion, this includes not only a case where the portion is “directly connected” but also a case where the portion is “electrically connected” with another element therebetween. Throughout the specification, when a part is said to “include” a certain component, this does not mean that other components are excluded, but rather that other components may be further included, unless otherwise specifically stated.

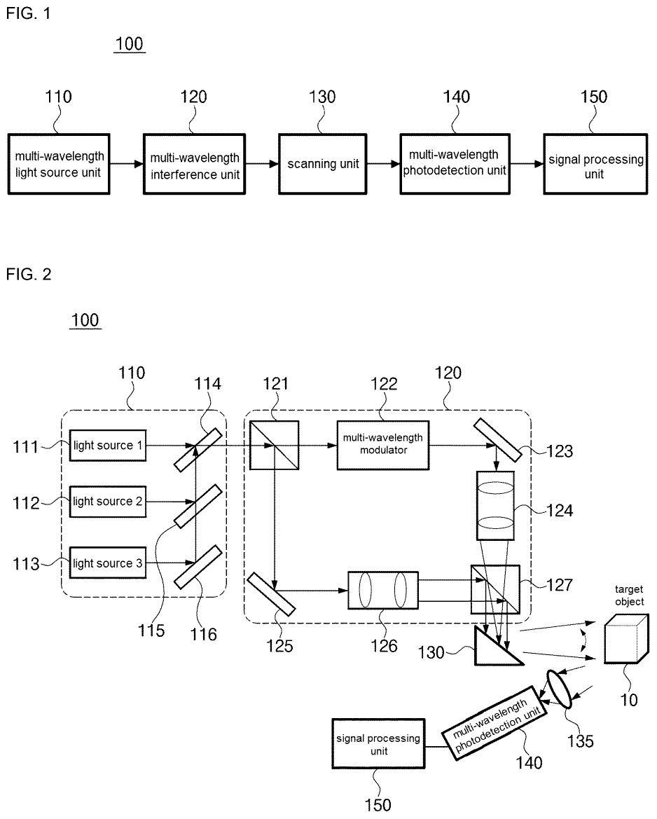

FIG. 1 is a diagram illustrating a configuration of a system for acquiring holograms of different colors, according to an embodiment of the present invention, and FIG. 2 is a diagram specifically illustrating a configuration of FIG. 1.

As illustrated in FIG. 1 and FIG. 2, a system 100 for acquiring holograms of different colors, according to an embodiment of the present invention, includes a multi-wavelength light source unit 110, a multi-wavelength interference unit 120, a scanning unit 130, a multi-wavelength photodetection unit 140, and a signal processing unit 150.

The multi-wavelength light source unit 110 includes light sources of multiple wavelengths. To this end, the multi-wavelength light source unit 110 may be configured to include at least two types of light sources of different wavelengths. Therefore, the multi-wavelength light source unit 110 may be implemented to include a first light source to an N^{th} light source (N is an integer greater than or equal to 2) having different wavelengths.

For the sake of convenience of description, FIG. 2 illustrates a case where light sources (light source 1, light source 2, and light source 3) of three wavelengths are used. In this case, when light sources (a light source R, a light source G, and a light source B) having wavelengths corresponding to red (R), green (G), and blue (B) are used as light sources of different wavelengths, a hologram of a natural color for a target object 10 may be acquired by a proposed system 100. Of course, the present invention is not limited thereto.

The multi-wavelength light source unit 110 may include various types of light sources having characteristics of coherence, such as a laser and an LED.

Referring to FIG. 2, the multi-wavelength light source unit 110 may include not only light sources 111, 112, and 113 having different wavelengths, but also a first wavelength-selective mirror 114, a second wavelength-selective mirror 115 with wavelength selectivity to combine lights having different wavelengths to pass through one path, and a first mirror 116. The wavelength-selective mirrors 114 and 115 have characteristics of reflecting light having a specific wavelength and transmitting light having another specific wavelength therethrough. Here, the respective wavelength-selective mirrors 114 and 115 may be implemented with dichroic mirrors, and the first mirror 116 may be implemented with a general mirror.

As illustrated in FIG. 2, the first wavelength-selective mirror 114, the second wavelength-selective mirror 115, and the first mirror 116 may be arranged side by side, and through the respective mirrors, for example, the light source 111 (light source 1) having a first wavelength, the light source 112 (light source 2) having a second wavelength, and the light source 113 (light source 3) having a third wavelength may be respectively incident side by side on the respective mirrors. When a hologram of a natural color is to be implemented, the light sources 1, 2, and 3 may respectively correspond to a red light source, a green light source, and a blue light source.

Here, the first wavelength-selective mirror 114 may receive the light source 1 (111) incident on one surface and output the light source 1 (111) from the other surface, and at the same time, receive the light source 2 (112) and light source 3 (113) incident on the other side through the second wavelength-selective mirror 115, and the first mirror 116, and reflect the light source 2 (112) and light source 3 (113), and accordingly, the first wavelength-selective mirror 114 may combine the three sources 111, 112, and 113 to pass through one path and transfer the combined light source to the multi-wavelength interference unit 120.

The second wavelength-selective mirror 115 may receive the light source 2 (112) incident on the one surface, and reflect the light source 2 (112) from the one surface to be transferred to the other surface of the first wavelength-selective mirror 114, and at the same time, transmit the light source 3 (113) having a different wavelength, therethrough and transfer the light source 3 (113) to the other surface of the first wavelength-selective mirror 114. The first mirror 116 may be implemented with a general mirror and reflect the light source 3 (113) incident on one surface, and transfer the light source to the other side of the second wavelength-selective mirror 115.

In this way, the multi-wavelength light source unit 110 may combine multiple light sources having different wavelengths by using the wavelength-selective mirrors to pass through one path and transfer the combined light source to the multi-wavelength interference unit 120.

FIG. 2 illustrates an implementation example of the multi-wavelength light source unit 110 when utilizing the light sources 1, 2, and 3 having three wavelengths. In the case of FIG. 2, the multi-wavelength light source unit 110 illustrates that two wavelength-selective mirrors DM and one mirror M are utilized as units of combining three light sources having different wavelengths to pass through one path.

However, the present invention is not limited thereto, and the same effect may be obtained by using three wavelength-selective mirrors corresponding to three light sources or even by using three beam splitters.

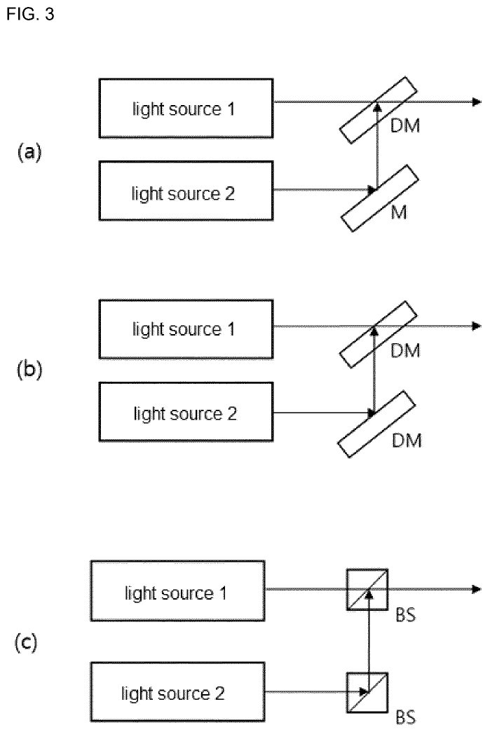

FIG. 3 illustrates diagrams of other examples of the multi-wavelength light source unit illustrated in FIG. 2.

In an embodiment of the present invention, the multi-wavelength light source unit 110 may be implemented by including at least two types of light sources (light source 1 and light source 2) having different wavelengths.

This FIG. 3 specifically illustrates various implementation examples of the multi-wavelength light source unit when two light sources having different wavelengths (wavelength 1 and wavelength 2) are utilized.

Here, as units for combining two light sources (light source 1 and light source 2) having different wavelengths to pass through one path, (a) of FIG. 2 is a case where one wavelength-selective mirror DM and one mirror M are utilized, (b) is a case where two wavelength-selective mirrors DM are utilized, and (c) is a case where two beam splitters BS are utilized.

From this point, in an embodiment of the present invention, the multi-wavelength light source unit 110 may include N light sources having different wavelengths and an optical path combining unit.

In this case, the optical path combining unit may be implemented with a structure including N−1 wavelength-selective mirrors DM and one mirror M, a structure including N wavelength-selective mirrors DM, or a structure including N beam splitters BS.

In the first structure, the first to Nth light sources may be individually incident on N−1 wavelength-selective mirrors DM and one mirror M arranged side by side, and then combined to pass through one path and output from the upper-most wavelength-selective mirror DM located at the end.

In the second structure, the first to Nth light sources may be individually incident on N wavelength-selective mirrors DM arranged side by side, and then combined to pass through one path and output from the upper-most wavelength-selective mirror DM located at the end.

In the third structure, the first to Nth light sources may be individually incident on N beam splitters BS arranged side by side, and then combined to pass through one path and output from the upper-most beam splitter BS located at the end.

The multi-wavelength interference unit 120 receives light sources having multiple wavelengths and generates a scan beam due to an interference phenomenon. To this end, the multi-wavelength interference unit 120 may be configured to include two beam splitters 121 and 127, two mirrors 123 and 125, one multi-wavelength modulator 122, and two beam curvature generators 124 and 126, as illustrated in FIG. 2.

The light combined in the multi-wavelength light source unit 110 to pass through one optical path is split into two lights to pass through different paths while passing through the first beam splitter 121. In this case, the light passing through one path (hereinafter, a first path) is transferred to the multi-wavelength modulator 122, and the light of the remaining path (hereinafter, the second path) is reflected through the mirror 125 and then transferred to the second beam curvature generator 126 to be expanded into a specific curvature beam. The light passing through the multi-wavelength modulator 122 is incident on the first beam curvature generator 124 and expanded into a beam having a specific curvature (a first curvature), and then passes through the second beam curvature generator 126 and is combined with the light expanded to a beam having a specific curvature (a second curvature) by the second beam splitter 127. The light transferred to the multi-wavelength modulator 122 may be modulated into light having a specific frequency.

A configuration of the multi-wavelength interference unit 120 is specifically described with reference to FIG. 2 below.

The first beam splitter 121 may receive the light source having combined multiple wavelengths from the multi-wavelength light source unit 110, splits the light source into beams respectively passing through a first path and a second path, and output the beams. This first beam splitter 121 may split light into two lights respectively passing through two paths by transmitting a part of an incident beam therethrough and transferring a part of the incident beam to the multi-wavelength modulator 122 and reflecting the rest of the incident beam and transferring the rest of the incident beam to the second mirror 123.

The multi-wavelength modulator 122 may receive a beam which is split by the first beam splitter 121 and passes through the first path, and spatially split the beam for each wavelength, recombine the split beams, and output the recombined beam.

The multi-wavelength modulator 122 may include an acousto-optic modulator (AOM) and an optical combiner arranged at the rear end thereof. The optical combiner may receive lights having different wavelengths split at different diffraction angles by the acousto-optic modulator (AOM), recombine the lights, and then propagate the recombined light to air.

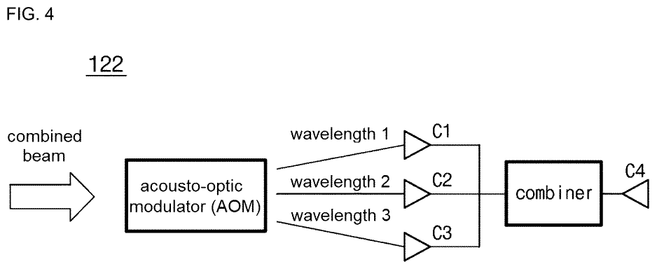

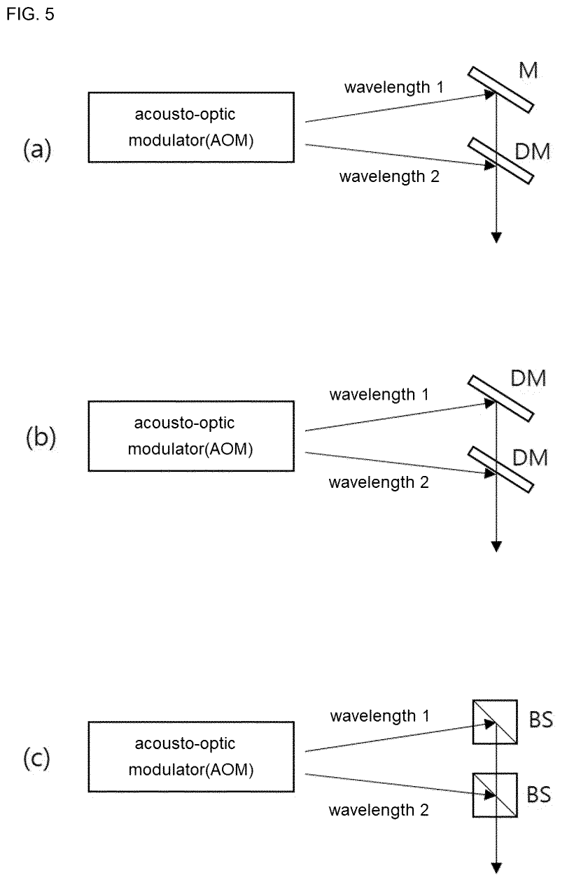

FIG. 4 below illustrates an optical combiner implemented as a combiner structure of an optical fiber shape, and FIG. 5 illustrates an optical combiner implemented as a combiner structure of a free space shape.

FIG. 4 is a diagram illustrating an implementation example of the multi-wavelength modulator of FIG. 2.

As illustrated in FIG. 4, the multi-wavelength modulator 122 may include the acousto-optic modulator (AOM), a combiner, a plurality of collimators C1, C2, and C3, and a terminal collimator C.

Here, when N beams having different wavelengths are utilized, a total of N collimators may be utilized between the acousto-optic modulator (AOM) and the terminal collimator C.

For the sake of convenience of description, FIG. 4 illustrates separation and combination of three beams having different wavelengths and outputting the combined beam. In this case, the three wavelength beams may respectively correspond to R, G, and B, and in this case, a hologram of a natural color for an object may be implemented. Of course, even when three beams having different wavelengths are utilized, the beams are not limited to wavelengths of R, G, and B.

In FIG. 4, the acousto-optic modulator (AOM) receives a beam which is split from the first beam splitter 121 and passes through the first path, modulates the beam into light of a set frequency, and outputs the light, but spatially splits the light at different diffraction angles for each wavelength and outputs the split lights.

This acousto-optic modulator (AOM) uses a Bragg condition, and in this case, a diffraction angle may be represented by Equation 1 below.

$${θ}_{B} \approx sin {θ}_{B} = \frac{λ}{2 n Λ} \qquad [ Equation 1 ]$$

Wherein λ represents a wavelength of the incident light, n represents a refractive index of a medium, and Λ represents a wavelength of a sound wave incident on the medium. As may be seen in Equation 1, the light modulated by the acousto-optic modulator (AOM) has a different diffraction angle depending on wavelengths.

The acousto-optic modulator (AOM) may modulate the beam, which is split by the first beam splitter 121 and passes through the first path, into light of a set frequency, and in this case, the modulated light may be split into light having different diffraction angles θ_{B} for each wavelength λ and propagates the lights into the air as represented by Equation 1.

The first to third collimators C1, C2, and C3 may receive lights having respective wavelengths transferred at different diffraction angles by the acousto-optic modulator (AOM) through lenses thereof optimized for the corresponding wavelengths and individually focus the lights onto respective optical fibers as illustrated in FIG. 4. Respective collimators C1 to C3 and the terminal collimator C may be implemented with an optical fiber-type collimator.

The combiner may receive lights having respective wavelengths focused by the multiple collimators C1, C2, and C3, combine the lights into one, and output the combined light through a single optical fiber. Here, when respective wavelengths are R, G, and B, a general RGB combiner may be utilized as the combiner. The beams output through the single optical fiber may be transferred to the terminal collimator C.

The terminal collimator C may receive the beam combined by the combiner and propagate the beam to a free space through a lens.

That is, simply referring to the embodiment of FIG. 4, the multi-wavelength modulator 122 uses one acousto-optic modulator (AOM). Also, assuming operations for R, G, and B, the red, green, and blue lights passing through the acousto-optic modulator (AOM) are diffracted at different angles and propagate into the air. The first collimator C1 may be composed of a lens optimized for red and may focus the light corresponding to the red wavelength into an optical fiber. The second collimator C2 may be composed of a lens optimized for green and focus the light corresponding to a green wavelength into an optical fiber. The third collimator C3 may be composed of a lens optimized for blue and focus the light corresponding to a blue wavelength into an optical fiber.

The combiner combines lights having different wavelengths into one optical fiber, and a combined beam (multi-wavelength combined beam) propagates into a free space through the terminal collimator C. In this case, a curvature of the light propagating in the free space changes depending on changes in position of a lens inside the terminal collimator C.

Here, the multi-wavelength modulator 122 may be implemented as an optical fiber-type combiner structure illustrated in FIG. 4, but may also be implemented as a free space-type combiner structure illustrated in FIG. 5.

FIG. 5 illustrates diagrams of other implementation examples of the multi-wavelength modulator of FIG. 2. The multi-wavelength modulator 122 illustrated in FIG. 5 may include an acousto-optic modulator (AOM) and an optical combiner implemented by including multiple mirrors or multiple beam splitters.

FIG. 5 illustrates an example of the multi-wavelength modulator 122 of a free-space type which is applicable in the case of utilizing two light sources having different wavelengths (wavelength 1 and wavelength 2).

An optical combiner, which is provided at a rear end of the acousto-optic modulator (AOM) and combines lights having different wavelengths propagating at different diffraction angles, includes a structure of FIG. 5 (a) illustrating one mirror M and one wavelength-selective mirror DM, a structure of FIG. 5 (b) illustrating two wavelength-selective mirrors DM, and a structure of FIG. 5 (c) illustrating two beam splitters BS.

Here, assuming a situation where N lights having different wavelengths are combined with each other by applying this, the optical combiner may be implemented with a structure including one mirror M and N−1 wavelength-selective mirrors DM, a structure including N wavelength-selective mirrors DM, or a structure including N beam splitters BS.

In the case of the first structure, beams having respective wavelengths may be individually incident on one mirror M and N−1 wavelength-selective mirrors DM arranged side by side, and then combined by the lowest wavelength-selective mirror DM located at the end to pass through one path and output.

In the second structure, beams having respective wavelengths may be individually incident on N wavelength-selective mirrors DM arranged side by side, and then combined to pass through one path and output from the lowest wavelength-selective mirror DM located at the end.

In the third structure, beams having respective wavelengths may be individually incident on N beam splitters BS arranged side by side, and then combined to pass through one path and output from the lowest beam splitter BS located at the end.

In this way, the multi-wavelength modulator 122 may be implemented with a structure including a single acousto-optic modulator (AOM) and an optical combiner in the form of an optical fiber as illustrated in FIG. 4, or a structure including a single acousto-optic modulator (AOM) and an optical combiner in the form of a free waveguide as illustrated in FIG. 5.

The combined beam modulated by the multi-wavelength modulator 122 and finally propagates into a free space may be reflected by the second mirror 123 and transferred to the first beam curvature generator 124, and the first beam curvature generator 124 may expand the beam and transfer the expanded beam to the second beam splitter 127.

In advance, the beam on the second path split from the first beam splitter 121 may also be reflected by the third mirror 125 and transferred to the second beam curvature generator 126, and the second beam curvature generator 126 may expand the incident beam and transfer the expanded beam to the second beam splitter 127.

The beam on the first path passing through the multi-wavelength modulator 122 may pass through the first beam curvature generator 124, and thereby, light having a specific curvature may be generated. The beam on the second path may pass through the second beam curvature generator 126, and thereby, light having a specific curvature may be generated. The first and second beam curvature generators 124 and 126 may be set to different curvatures or to the same curvature as required.

Here, the first and second beam curvature generators 124 and 126 may each receive a beam and generate an expanded beam having a curvature between a negative curvature and a positive curvature, by including a collimated beam.

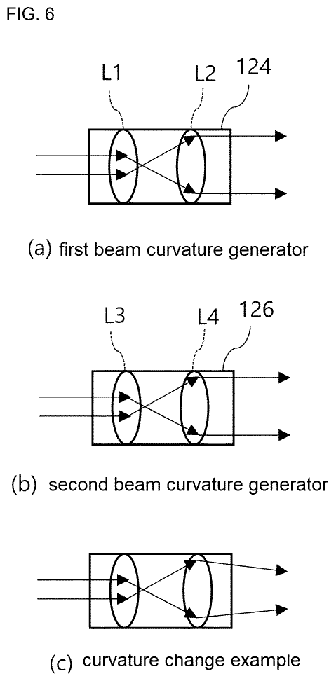

FIG. 6 illustrates diagrams of implementation examples of a beam curvature generator according to an embodiment of the present invention. FIG. 6 (a) illustrates a first beam curvature generator, (b) illustrates a second beam curvature generator, and (c) illustrates an example of a change in curvature of a beam passing through the first beam curvature generator.

In a specific implementation example of the first beam curvature generator 124, a beam, which is reflected from the mirror 123 and passes through the first path, passes through the first beam curvature generator 124, and thereby, a spherical wave having a curvature may be generated. The first beam curvature generator 124 may include a first lens L1 that converts the beam, which is reflected from the mirror 123 and passes through the first path, into a spherical wave and a second lens L2 that receives the spherical wave and generates a spherical wave having a curvature (a beam of a first curvature). In this case, a curvature of the beam may be adjusted by changing a distance between the first lens L1 and the second lens L2.

In a specific implementation example of the second beam curvature generator 126, a beam, which is reflected from the mirror 125 and passes through the second path, passes through the second curvature beam generator 126, and thereby, a spherical wave having a curvature (a second curvature beam) may be generated. Specifically, the second beam curvature generator 126 may include a third lens L3 that converts a beam, which is reflected from the mirror 125 and passes through the second path, into a spherical wave and a fourth lens L4 that receives the spherical wave and generates a spherical wave having a curvature. In this case, a curvature of the beam may be adjusted by changing a distance between the third lens L3 and the fourth lens L4.

The first beam curvature generator 124 converts the beam passing through the first path into a beam having the first curvature and transfers the beam to the second beam splitter 127. That is, the first beam curvature generator 124 modulates a spatial distribution of the beam passing through the first path and generates a beam having the first curvature.

The second beam curvature generator 126 converts a beam passing through the second path into a beam having the second curvature and transfers the beam to the second beam splitter 127. That is, the second beam curvature generator 126 modulates a spatial distribution of the beam passing through the second path and generates a beam having the second curvature.

The second beam splitter 127 receives the beam that passes through the first beam curvature generator 124 and then passes through the first path and receives, through different surfaces, the beam which is split by the first beam splitter 121 and passes through the second beam curvature generator 126 and passes through the second path, and combines the beams to generate a scan beam having a pattern of a Fresnel plate due to an interference effect caused by coherence characteristics of a light source between the beams.

In this case, the pattern of the Fresnel plate may be determined according to a difference between a curvature of the beam generated by the first beam curvature generator 124 and a curvature of the beam generated by the second beam curvature generator 126.

In this way, in the embodiment of the present invention, lights having different wavelengths that are spatially split according to a change in different diffraction angles according to wavelength characteristics may be individually focused into optical fibers by using one acousto-optic modulator (AOM).

The scanning unit 130 may scan the target object 10 by using a scan beam having a pattern of the Fresnel plate formed by the multi-wavelength interference unit 120. This scanning unit 130 may include various scanning modules, such as a galvanic mirror, a polygon mirror, a resonant mirror, and a DMD. However, because scanning is performed by using lights having different wavelengths, the mirrors used for a scanning module have to be able to use lights having different wavelengths.

The multi-wavelength photodetection unit 140 may detect the beams reflected from or transmitting through the target 10 for each wavelength and convert the beams into electrical signals. Here, FIG. 2 illustrates that beams reflected from the target 10 are detected for each wavelength, when the target 10 is a transmissive target rather than a reflective target, the multi-wavelength photodetection unit 140 may be placed at a rear end of the target 10 to detect beams transmitting through the target 10 for each wavelength.

Here, the multi-wavelength photodetection unit 140 may include a beam separation unit that receives a beam reflected from or transmitting through a target and splits the beam for each wavelength, and N photodetectors that individually detect N beams having respective wavelengths split by the beam separation unit and convert the beams into electrical signals.

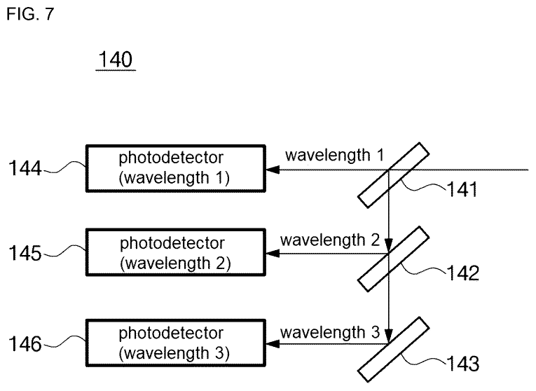

FIG. 7 is a diagram specifically illustrating a configuration of the multi-wavelength photodetection unit of FIG. 2. FIG. 7 is an example of a case where light sources (light source 1, light source 2, and light source 3) having three wavelengths are used.

Referring to FIG. 7, the multi-wavelength photodetection unit 140 may include a beam separation unit that splits beams having respective wavelengths from a beam reflected from or transmitting through the target object 10, and first to third photodetectors 144, 145, and 146 that detect the split beams having respective wavelengths and convert the beams into electrical signals.

The multi-wavelength photodetection unit 140 may split lights having different wavelengths by using a wavelength selective mirror and then convert the lights into electrical signals by using individual photodetectors.

To this end, the beam separation unit may include a third wavelength selective mirror 141, a fourth wavelength selective mirror 142, and a fourth mirror 143 that are arranged side by side.

When a hologram of a natural color is to be implemented, the third wavelength-selective mirror 141 may receive a beam reflected from or transmitting through the target object 10, transmit a beam having a first wavelength (R, red light) therethrough and transfer the beam to the first photodetector 144. The fourth wavelength-selective mirror 142 may reflect the beam having a second wavelength (G) among a beam having the beam having the second wavelength (G, green light) and a beam having a third wavelength (B, blue light) reflected from the third wavelength-selective mirror 141 and transfer the beam to the second photodetector 145 and transmit the beam having the third wavelength (B) therethrough and transfer to the fourth mirror 143 at a lower end. Then, the fourth mirror 143 may reflect the beam having the third wavelength (B) received from the fourth wavelength-selective mirror 142 and transfer the beam to the third photodetector 146. Of course, the implementation example of the hologram of a natural color using lights of three colors of RGB is only one embodiment, and the embodiments of the present invention are not limited thereto.

The respective photodetectors 144, 145, and 146 may detect beams having respective wavelengths received, convert the beams into electrical signals, and then simultaneously transfer the electrical signals to the signal processing unit 150.

Of course, in another embodiment, the multi-wavelength photodetector 140 may use a method of sequentially detecting information of beams (for example, R, G, and B) corresponding to different wavelengths over time by using a single photodetector without using two wavelength selective mirrors 141 and 142 and the mirror 143.

That is, the multi-wavelength photodetector 140 may be implemented with a single photodetector, and in this case, may receive beams reflected from or transmitting through a target object and sequentially detect beams having different wavelengths over time.

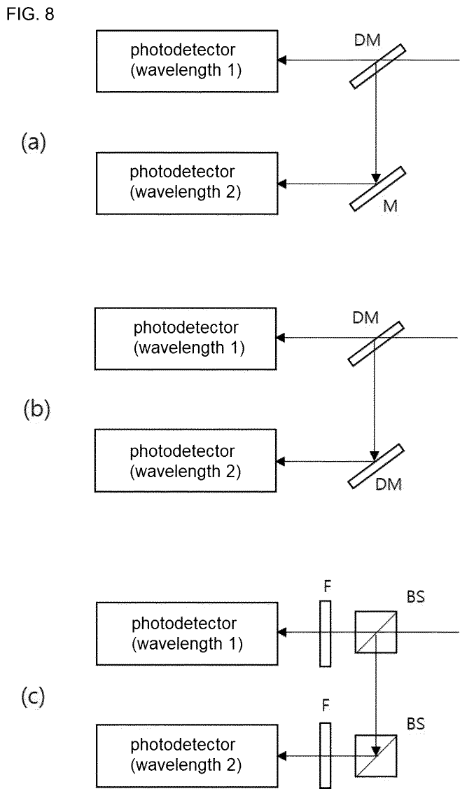

FIG. 8 illustrates diagrams of other implementation examples of the multi-wavelength photodetection unit of FIG. 2. FIG. 8 illustrates various examples of the multi-wavelength photodetection unit that is applicable to a case where two light sources having different wavelengths (wavelength 1 and wavelength 2) are utilized.

In this case, FIG. 8 (a) is a case where one wavelength-selective mirror DM and one mirror M are utilized, (b) is a case where two wavelength-selective mirrors DM are utilized, and (c) is a case where two beam splitters BS and two color filters F are utilized.

Here, assuming a situation where N lights having different wavelengths are detected respectively by applying this, a beam separation unit of the multi-wavelength photodetection unit 140 may be implemented with a structure including N−1 wavelength-selective mirrors DM and one mirror M, a structure including N wavelength-selective mirrors DM, or a structure including N beam splitters BS and N color filters F.

In the first structure, the beam separation unit may be composed of a total of N mirror elements including N−1 wavelength-selective mirrors DM and one mirror M, and receive beams reflected from or transmitting through a target object through one of the wavelength-selective mirrors DM at the end, and then split and output the beams for each wavelength through the N mirror elements, and individually transfer the beams to N photodetectors.

In the second structure, the beam split unit may be composed of the N wavelength-selective mirrors DM, receive beams reflected from or transmitting through the target object through one of the wavelength-selective mirrors DM at the end, and then split and output the beams for each wavelength through the N wavelength-selective mirrors and individually transfer the beams to N photodetectors.

In the third structure, the beam split unit may be composed of the N beam splitters BS and N color filters F that filter beams having different wavelengths, receive the beam reflected from or transmitting through the target object through one of the beam splitters BS at the end, and then split the beams into N beams through the N beam splitters and individually transfer the split beams to the N color filters F, and the beams split and output for each wavelength through the N color filters F may be individually transferred to the N photodetectors.

Meanwhile, as illustrated in FIG. 2, the multi-wavelength photodetection unit 140 may be implemented by including a separate light collector 135 to improve light collection efficiency, and the light collector 135 may include various photodetection units, such as a photodiode and a PMT.

Information of the target object 10 converted into an electrical signal form by the multi-wavelength photodetector 140 may be restored through numerical processing by a signal processing unit 150. The process of numerically processing a signal may be represented in Equation 2 below.

$${H}_{com} ( x , y ) ∝ \int {I}_{0} ( x , y ; z ) ⊗ \frac{j}{λ z} exp \{ j \frac{π}{λ z} ( {x}^{2} ⋆ {y}^{2} ) \} dz . \qquad [ Equation 2 ]$$

Here, lₒ(x,y;z) may represent the light reflected from the target object 10 or the light detected by the photodetection unit 140 after passing through the target object 10, ⊗ may represent a convolution operation,

$$exp \{ j \frac{π}{λ z} ( {x}^{2} ⋆ {y}^{2} ) \}$$

may represent a pattern of a beam in the form of a Fresnel plate formed by an interference unit (second beam splitter, 127) of a holographic system 100 based on scanning holography. Additionally, H_{com}(x,y) represents a hologram information of a target object, ∝ represents a proportional symbol, and λ represents a wavelength of a used beam.

According to the present invention described above, it is possible to acquire hologram information of various wavelengths for an object by using only a single acousto-optic modulator.

Also, unlike the general method of using multiple acousto-optic modulators for signal processing of different multiple wavelengths, only one acousto-optic modulator is required, and thus, a size of the entire system for acquiring holograms of different colors may be reduced.

Although the present invention is described with reference to the embodiments illustrated in the drawings, the embodiments are merely examples, and those skilled in the art will understand that various modifications and equivalent other embodiments may be derived therefrom. Therefore, the true technical protection scope of the present invention should be determined by the technical idea of the appended patent claims.

1. A system for acquiring hologram of different colors, the system comprising:
a multi-wavelength light source unit that generates light sources having multiple wavelengths;
a multi-wavelength interference unit that receives the light sources having the multiple wavelengths and generates a scan beam due to an interference phenomenon;
a scanning unit that scans a target object by using the scan beam;
a multi-wavelength photodetection unit that detects beams reflected from or transmitting through the target object for each wavelength and converts the beams into electrical signals; and
a signal processing unit that numerically processes the electrical signals.

2. The system for acquiring the hologram of different colors of claim 1,
wherein
the multi-wavelength light source unit includes a first wavelength-selective mirror, a second wavelength-selective mirror, and a first mirror, which are arranged side by side and on which light sources respectively having a first wavelength, a second wavelength, and a third wavelength, each of which is selected from red light, green light, and blue light, are respectively incident side by side, and
the first wavelength-selective mirror transmits the light source having the first wavelength incident on one surface of the first wavelength-selective mirror therethrough, reflects the light sources respectively having the second wavelength and the third wavelength incident on another surface of the first wavelength-selective mirror through the second wavelength-selective mirror and the first mirror, combines the light sources respectively having the first wavelength, the second wavelength, and the third wavelength to pass through one path, and transfers a combined light source to the multi-wavelength interference unit.

3. The system for acquiring the hologram of different colors of claim 1,
wherein
the multi-wavelength light source unit includes an optical path combining means that receives first to N^{th} light sources (N is an integer of 2 or more) having different wavelengths, combines the first to N^{th} light sources to pass through one path, and outputs a combined light source, and
the optical path combining means has a structure in which the first to N^{th} light sources are individually incident through N−1 wavelength-selective mirrors and one mirror arranged side by side and are combined to pass through the one path by a wavelength-selective mirror located at an end to be output.

4. The system for acquiring the hologram of different colors of claim 1,
wherein
the multi-wavelength light source unit includes an optical path combining means receives first to N^{th} light sources (N is an integer of 2 or more) having different wavelengths, combines the N^{th} light sources to pass through one path, and output a combined light source, and
the optical path combining means has a structure in which the first to N^{th} light sources are individually incident through N wavelength-selective mirrors arranged side by side and are combined to pass through the one path by a wavelength-selective mirror located at an end to be output.

5. The system for acquiring the hologram of different colors of claim 1,
wherein
the multi-wavelength light source unit includes an optical path combining means receives first to N^{th} light sources (N is an integer of 2 or more) having different wavelengths, combines the N^{th} light sources to pass through one path, and output a combined light source, and
the optical path combining means has a structure in which the first to N^{th} light sources are individually incident through N beam splitters arranged side by side and are combined to pass through the one path by a beam splitter located at an end to be output.

6. The system for acquiring the hologram of different colors of claim 1,
wherein
the multi-wavelength interference unit includes:
a first beam splitter that receives light sources having multiple wavelengths, splits the light sources into beams that pass through a first path and a second path, and outputs the beams;
a multi-wavelength modulator that receives the beam that is split by the first beam splitter and passes through the first path, spatially splits the beam into multiple beams for each wavelength, combines the multipole beams, and outputs a recombined beam; and
a second beam splitter that receives the beam passing through the first path through the multi-wavelength modulator and the beam that is split by the first beam splitter and passes through the second path, and interferes the beams with each other to generate the scan beam.

7. The system for acquiring the hologram of different colors of claim 6,
wherein
the multi-wavelength modulator includes:
an acousto-optic modulator that modulates the beam passing through the first path into light having a set frequency and outputs lights obtained by spatially splitting the light for each wavelength at different diffraction angles; and
an optical combiner that recombines the lights having respective wavelengths spatially split and output by the acousto-optic modulator and propagates the lights into a free space.

8. The system for acquiring the hologram of different colors of claim 7,
wherein
the acousto-optic modulator modulates the beam passing through the first path into light having a set frequency and outputs the light, and split the light into multiple lights for each wavelength λ at different diffraction angles θ_{B} by using an equation below and propagates the multiple lights into the air,
$${θ}_{B} \approx sin {θ}_{B} = \frac{λ}{2 n Λ}$$
where, λ represents a wavelength of incident light, n represents a refractive index of a medium, and Λ represents a wavelength of a sound wave incident on the medium.

9. The system for acquiring the hologram of different colors of claim 7,
wherein
the optical combiner includes:
multiple collimators that receive lights having respective wavelengths split by the acousto-optic modulator through lenses corresponding to the corresponding wavelengths and individually focus the lights onto respective optical fibers;
a combiner that receives lights having respective wavelengths focused by the multiple collimators, combines the lights into one light, and outputs the one light through a single optical fiber; and
a terminal collimator that receives a beam combined by the combiner and propagates the beam into a free space.

10. The system for acquiring the hologram of different colors of claim 7,
wherein
the optical combiner has a structure in which N beams having different wavelengths are individually incident through one mirror and N−1 wavelength-selective mirrors arranged side by side and are combined to pass through one path by a wavelength-selective mirror located at an end to be output.

11. The system for acquiring the hologram of different colors of claim 7,
wherein
the optical combiner has a structure in which N beams having different wavelengths are individually incident through N wavelength-selective mirrors arranged side by side and are combined to pass through one path by a wavelength-selective mirror located at an end to be output.

12. The system for acquiring the hologram of different colors of claim 7,
wherein
the optical combiner has a structure in which N beams having different wavelengths are individually incident through N beam splitters arranged side by side and are combined to pass through one path by a beam splitter located at an end to be output.

13. The system for acquiring the hologram of different colors of claim 6,
wherein
the multi-wavelength interference unit further includes:
a first beam curvature generator that receives a beam passing through a first path through the multi-wavelength modulator, converts the beam into a spherical wave having a first curvature, and transfers the spherical wave to the second beam splitter; and
a second beam curvature generator that converts a beam, which is split by the first beam splitter and passes through a second path, into a spherical wave having a second curvature and transfers the spherical wave to a second beam splitter.

14. The system for acquiring the hologram of different colors of claim 13,
wherein
the second beam splitter combines the beam passing through the first path through the first beam curvature generator and the beam passing through the second path through the second curvature generator and generates a scan beam having a pattern of a Fresnel plate according to an interference effect due to coherence characteristics of a light source between beams.

15. The system for acquiring the hologram of different colors of claim 2,
wherein
the multi-wavelength photodetection unit includes:
a beam separation unit that receives beams reflected from or transmitting through a target object and splits the beams for each wavelength; and
N photodetectors that detect the N beams having respective wavelengths split by the beam separation unit and convert the N beams into electrical signals.

16. The system for acquiring the hologram of different colors of claim 15,
wherein
the beam split unit includes a third wavelength-selective mirror, a fourth wavelength-selective mirror, and a second mirror arranged side by side, the third wavelength-selective mirror receives the beams reflected from or transmitting through the target object, transmits a beam having the first wavelength therethrough, and transfers the beam to a first photodetector, the fourth wavelength-selective mirror reflects a beam having the second wavelength among beams respectively having the second wavelength and the third wavelength, which are reflected from the third wavelength-selective mirror and transfers the beam having the second wavelength to a second photodetector, and transmits the beam having the third wavelength therethrough and transfers the beam having the third wavelength to the second mirror, and
the second mirror reflects the beam having the third wavelength received from the fourth wavelength-selective mirror and transfers the beam having the third wavelength to a third photodetector.

17. The system for acquiring the hologram of different colors of claim 3,
wherein
the multi-wavelength photodetector comprises:
a beam split unit that receives beams reflected from or transmitting through the target object and splits the beams for each wavelength; and
N photodetectors that detect beams having N wavelengths split by the beam separator and convert the beams into electrical signals.

18. The system for acquiring the hologram of different colors of claim 17,
wherein
the beam split unit is composed of a total of N mirror elements including N−1 wavelength-selective mirrors and one mirror, receives the beams reflected from or transmitting through the target object through one of wavelength-selective mirrors at an end, splits the beams for each wavelength through the N mirror elements, and individually transfers split beams to the N photodetectors.

19. The system for acquiring the hologram of different colors of claim 17,
wherein
the beam split unit is composed of N wavelength-selective mirrors, receives the beams reflected from or transmitting through the target object through one of wavelength-selective mirrors at an end, splits the beams for each wavelength through the N wavelength-selective mirrors, and individually transfers split beams to the N photodetectors.

20. The system for acquiring the hologram of different colors of claim 17,
wherein
the beam split unit is composed of N beam splitters and N color filters that respectively filter beams having different wavelengths, receives the beams reflected from or transmitting through the target object through one of beam splitters at an end, splits the beams into N beams through the N beam splitters, individually transfers the N beams to the N color filters, and individually transfers beams split for each wavelength through the N color filters to the N photodetectors.
